(19) United States
(12) Patent Application Publication
(10) Pub. No.: US 2004/0258512 A1
(43) Pub. Date: Dec. 23, 2004

(54) Transit bus rear lifting cradle

(76) Inventors: Pablo Nolasco, Corona, NY (US); Harry Brown, Bay Shore, NY (US)

Correspondence Address: ALFRED M. WALKER, 225 OLD COUNTRY ROAD, MELVILLE, NY, 11747-2712, US

(21) Appl. No.: 10/695,576

(22) Filed: Oct. 28, 2003

Related U.S. Application Data
(60) Provisional application No. 60/476,112, filed on Jun. 5, 2003.

(51) Int. Cl. B66C 1/00

(52) U.S. Cl. 414/563

(57) ABSTRACT

A rear-lifting cradle lifts the rear of a modern transit bus by a wrecker even if it not designed for such lifting. A minimum of bus modification is needed for the use of this cradle. The cradle includes an assemblage of robust steel tube members including a crossbar, two frame extenders, and two slider arms. The bus modifications include replacing the rear plate of each of the two rear axle stabilizers. The two frame extenders couple into square holes in the replaced rear stabilizer plates while the posts bear on the top surface of the frame extenders. The slider arms have short columns and locator pins, which fit into the holes of the rear jacking plates, which are part of the bus. When the upwardly open forks of the lifting arms of a wrecker engage the crossbar of this rear-lifting cradle, the bus is lifted with the major stresses coupled into the main structural bus frame. Any residual lifting stresses are spread into the two rear jacking points, which are sufficiently robust to accept jacking stresses. This four-point stress lifting displacement successfully allows the bus to be towed with a conventional towing vehicle.

### RELATED APPLICATION

This application claims the benefit under 35 USC 119(e) of provisional patent application No. 60/476,112 filed Jun. 5, 2003.

### FIELD OF THE INVENTION

The present invention relates to towing heavy-duty mass transit buses.

### BACKGROUND OF THE INVENTION

Modern transit buses are designed for low pollution, good fuel economy, and may have features to accommodate persons with limited climbing abilities. Such a vehicle is the Orion VII Low Floor transit bus from Daimler Chrysler. To accommodate a variety of power plants including diesel, CNG, and diesel-electric hybrid, the engine placement of these modern buses is significantly forward of the rear axle. It is a “kneeling” bus with step height that varies from 14.5 inches to 11 inches in the kneeled position.

With all of these features, the frame configuration of this bus differs from that of past generations. The bus has a long cantilevered rear overhang beyond the rear axle, and the main structural frame does not extend to the rear bumper. Although adequate strength is maintained in the rear quarter for normal operation, including tire changing jacking, the design of the frame configuration does not permit rear lifting by a tow truck or wrecker. The need for rear lifting is minimized by the improved reliability of these buses, however in some municipal jurisdictions this capability is required to quickly move disabled buses.

### OBJECTS OF THE INVENTION

It is therefore an object of the present invention to provide a lifting cradle for transit buses with long rear-cantilevered overhangs.

It is also an object of the present invention to provide a lifting cradle for a heavy duty transit bus which does not damage the undercarriage of the bus and which promotes safe and efficient removal of disabled transit buses.

Other objects will become apparent from the following description of the present invention.

### SUMMARY OF THE INVENTION

In keeping with these objects and others, which may become apparent, the present invention is a four-point rear-lifting cradle, which permits lifting the rear of a modern transit bus by a wrecker even if it not designed for such manipulation. A minimum of bus modification is needed for the use of this cradle. The cradle provides a four-point stress lifting displacement, which successfully allows the bus to be towed with a conventional towing vehicle

The cradle includes an assemblage of robust steel tube members including a crossbar, two frame extenders, and two lateral slider arms. The bus modifications include adding an undercarriage support plate on each of the two rear axle stabilizers. The two frame extenders couple into square holes in the replaced rear stabilizer plates, while existing downwardly extending jack posts bear on the top surface of the frame extenders. The slider arms have short columns and upwardly extending locator pins, which fit into the holes of the rear jacking plates, which are part of the rear corners of the bus.

When the upwardly open forks of the lifting arms of a tow truck wrecker engage the crossbar of this rear-lifting cradle, the bus is lifted with the major stresses coupled into the main structural bus frame. Any residual lifting stresses are spread into the two rear jacking points, which are sufficiently robust to accept jacking stresses.

The rear-lifting cradle of the present invention enhances the lifting of transit buses with long rear overhangs by incorporating both long, forward extending frame extenders, which engage a stable part of the bus frame. The addition of corner lift posts to lift the rear corners of the bus greatly enhances the spreading of lifting force, while maintaining its utility as a lifting cradle without damaging the long cantilevered overhang of the bus.

The use of the existing downwardly extending forward jack posts provides the lifting cradle with force from above which stabilizes the long extender arms needed to reach underneath the long cantilevered overhand of the rear of the mass transit bus.

The important weight distribution function of the lifting cradle for the bus is maintained with the aforementioned features. The synergistic combination of the long extender arms meeting with intact stabilizer arm plates with the extender arms uniquely engaging existing downwardly extending posts, together with corner lift posts, provide beneficial effects for lifting modern transit buses that are not possible with any other type of lifting cradle.

In a preferred embodiment, the lifting cradle includes strong steel tubing members with square or rectangular crossections, with hollow steel tubing collars joining the steel tubing members. The steel tubing of the frame extenders pass through cutouts in the steel plates, which are permanently bolted to the bus undercarriage, such as, for example, to the ends of the axle stabilizer arms. However, the steel plates can be attached to any part of the bus undercarriage having structural stability, in the vicinity of the rear wheel axle. To spread the weight, two upwardly extending pins located on the adjustable slider arms, rest in rear corners of the bus subframe used to lift a corner of the bus to change a flat tire.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of the rear body portion of a transit bus, with the lifting cradle of the present invention engaged.

FIG. 2 is an exploded perspective view of the components of the lifting cradle, adjacent the lift arm of a wrecker vehicle.

FIG. 3 is a perspective view of the assembled lifting cradle installed on the lift arm of a typical wrecker vehicle.

FIG. 4 is a side elevation view of the lifting cradle engaged to a transit bus, prior to lifting.

FIG. 5 is a view similar to FIG. 4, but showing the transit bus raised to towing position and illustrating the transfer of stresses involved as the rear of the bus is lifted.

### DETAILED DESCRIPTION OF THE INVENTION

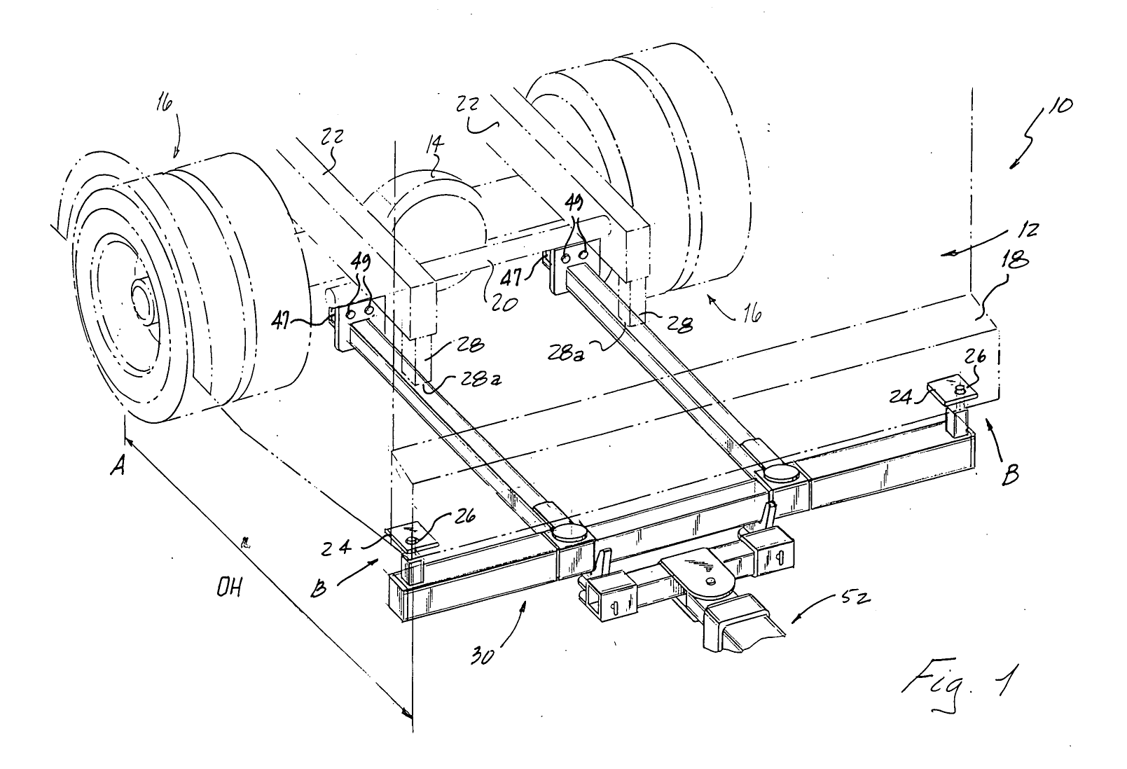

FIG. 1 is a perspective view of the rear body portion 12 of a transit bus 10, shown in phantom for clarity. “A” denotes the location of the centerline of rear axle 14 attached to wheel/tire unit 16. OH is the measurement from A to the rear bumper 18. This overhang dimension is important in that the bus body 12 is significantly cantilevered to the rear of axle 14, with no structural support. Rear axle stabilizer 20 and main structural frame rails 22 are located at a considerable distance from the rear of the transit bus. The jacking point for changing rear tires is shown at point B, where jack plates 24 with locator holes 26 are installed.

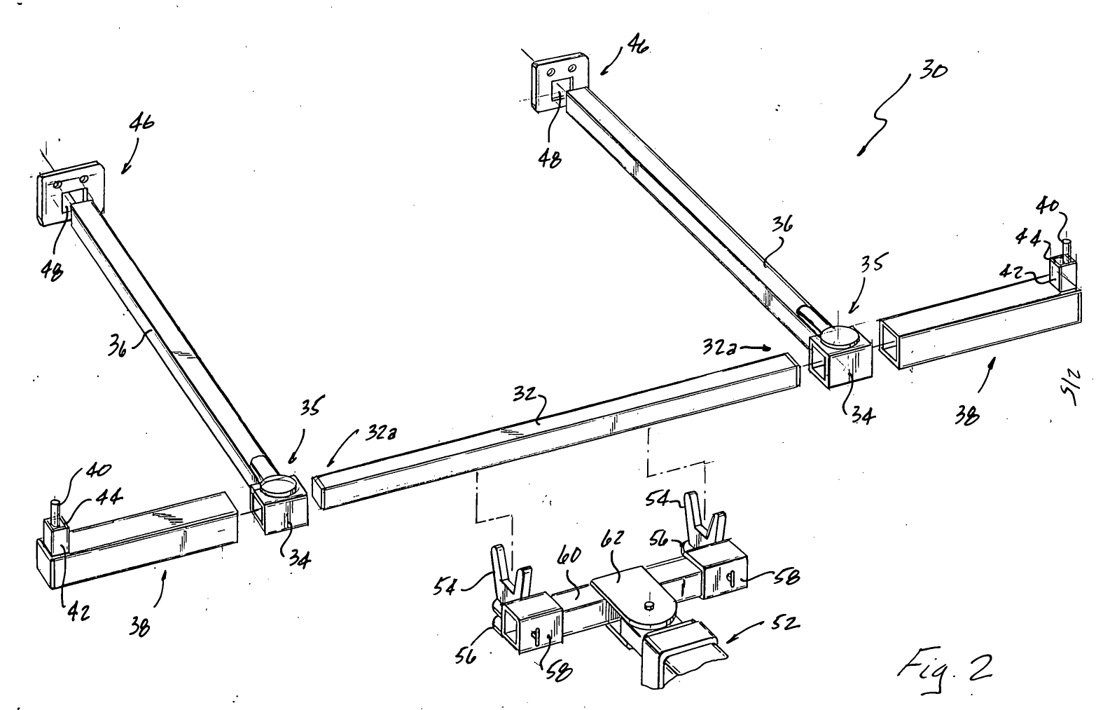

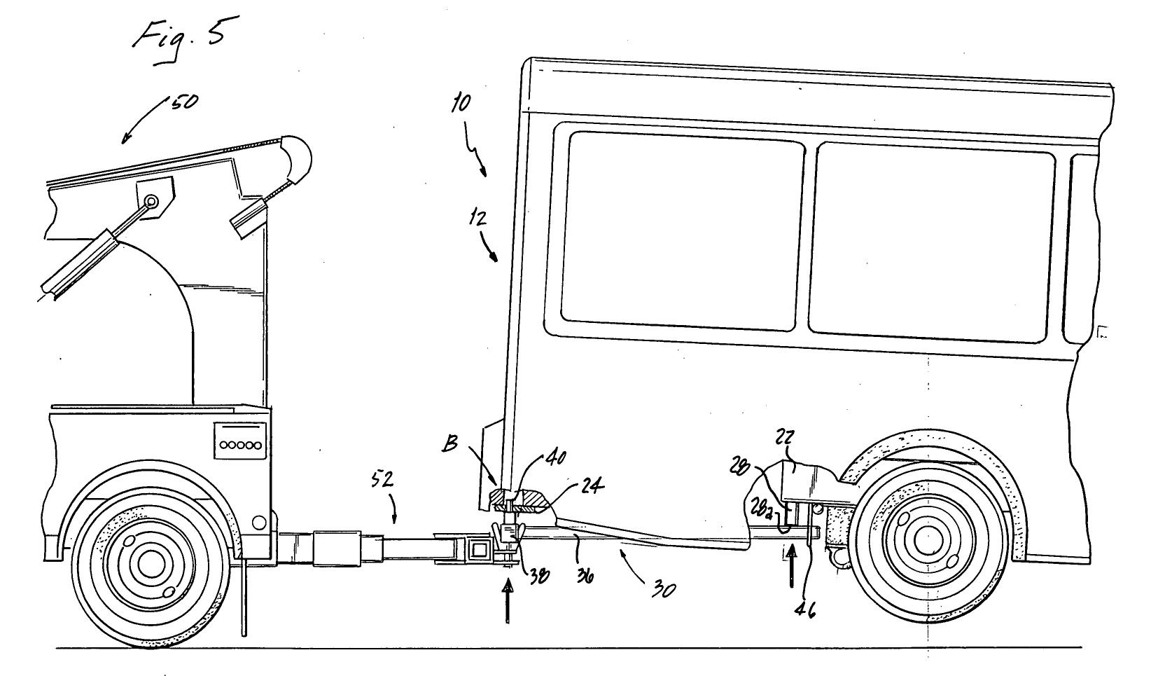

FIG. 2 shows the various components of the lifting cradle 30 of the present invention. Crossbar 32 slips through box collar sections 34, which are welded to tubular frame extenders 36, and reinforced at 35 with welded plates. Slider arm members 38 are slipped over the distal ends 32a of crossbar 32, and abut the box collars 34, as shown in FIG. 1. Upwardly extending pins 40 are welded into collars 42, with top surfaces 44. As shown in FIG. 1, pins 40 are inserted into jack plate locator holes 26, and surfaces 44 will abut and urge the jack plates 24 during the lift. Stabilizer plates 46 with square apertures 48, are custom fabricated and permanently attached to existing stabilizer brackets 47, with bolts 49. As shown in FIG. 1, downwardly extending steel jack posts, 28, are conventionally welded to the bus frame rails 22 during bus manufacture. Frame extenders 36 will abut the underside surfaces 28a of these posts during the lift and urge them upwardly, as shown in FIG. 5.

The lifting structural tubes of the present invention are very robust. Although other dimensions may be appropriate, in one preferred application, crossbar 32 is 80 inches long and frame extenders 36 are 83 inches long. They are both made preferably of square steel tubing of about 3″×3″×5/16″ in crossection. The slider arms 38 are preferably about 3.5″×3.5″×3/16″ in crossection.

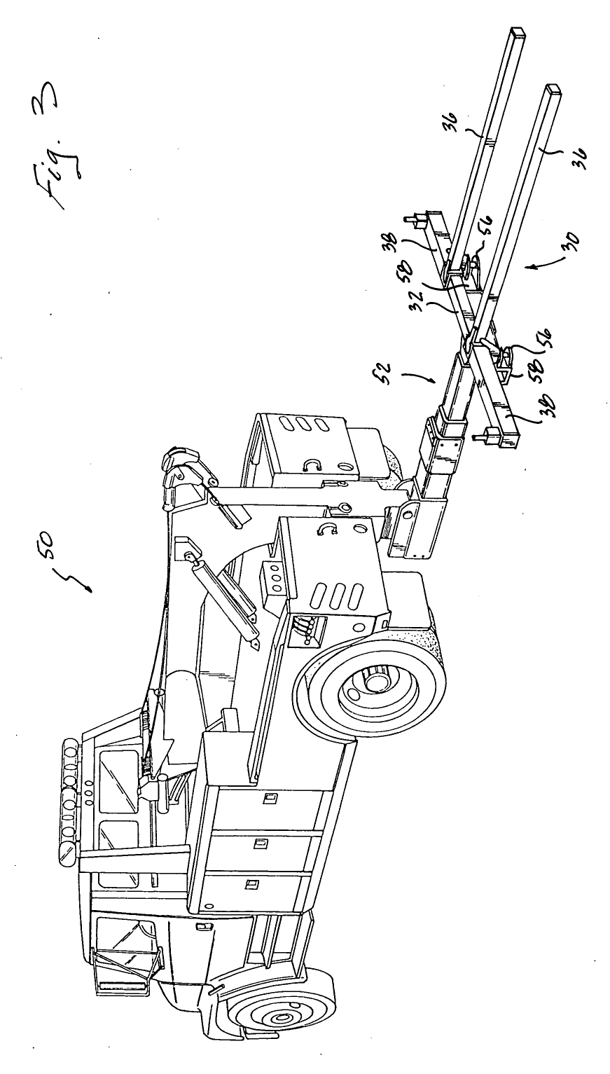

FIG. 3 is a perspective view of a typical wrecker truck 50, with an extendible arm 52. As shown in FIGS. 1 and 2, arm 52 is equipped with accessories designed to engage and support lifting cradle 30. As best seen in FIG. 2, crossbar 32 of lifting cradle 30, will rest in forks 54. Forks 54 are known in the industry, and are removable from support plates 56, which are welded to tubular collars 58. These collars 58 are installed on wrecker bar 60, typically for a heavy lifting operation. Wrecker bar 60 is welded to clevis 62, which is pinned to extendable arm 52, and allows for rotation of bar 60 to facilitate vehicle recovery in tight situations.

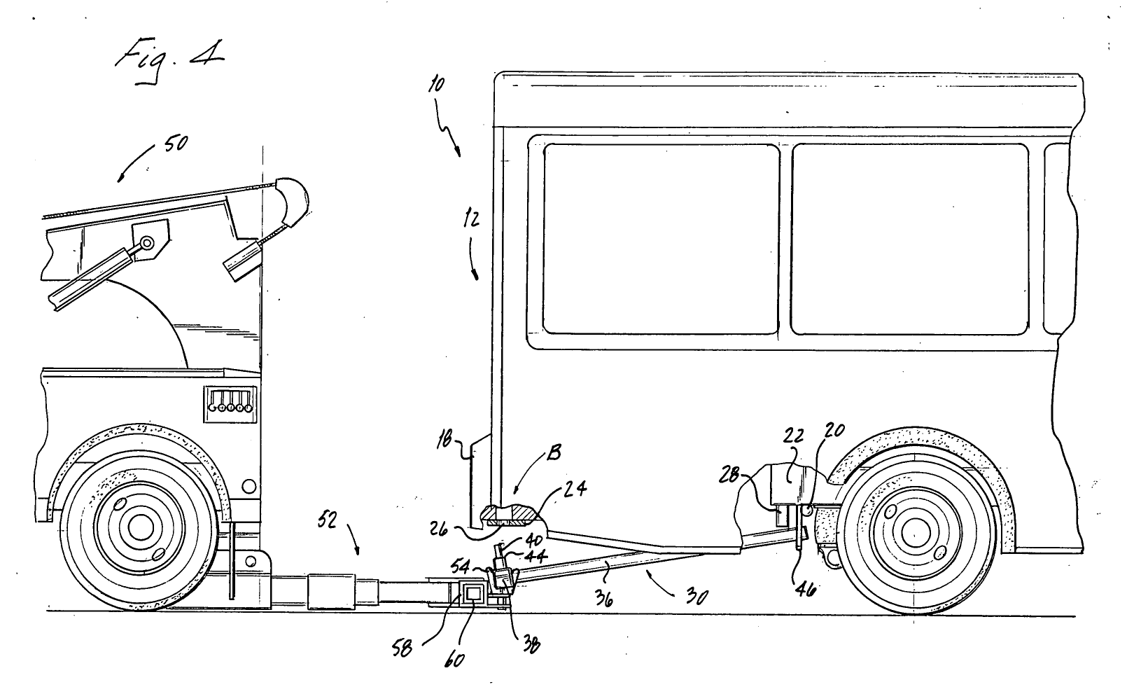

FIG. 4 is a side elevation of wrecker truck 50, prior to lifting of a disabled transit bus 10. During a recovery operation, the tow operator will insert frame extenders 36 into apertures 48 of stabilizer plates 46. The crossbar 32 is then passed through box collar sections 34, with slider arm members 38 added to distal portions 32a of crossbar 32 to complete the cradle. Due to the robustness of the tube components, it is preferable that the crossbar 32 is resting in forks 54 during assembly of the cradle. As wrecker arm 52 is lifted, forks 54 will raise crossbar 32, thereby lifting frame extenders 36 to a more horizontal position. Frame extenders 36 will abut the undersides 28a of jack posts 28, and pins 40 will slide into holes 26 of plates 24, with upper surfaces 44 eventually contacting these plates.

FIG. 5 is an elevation view of the bus 10 in the raised position. All torque generated from wrecker arm 52 is transferred to bus frame rails 22 via the frame extenders 36 and jack posts 28. As seen in this view, the lifting cradle 30 of this invention reinforces the entire rear body portion 12 of transit bus 10, due to the four lift points displacing all stresses. The bus is now completely supported and towable with a conventional wrecker vehicle.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

If is further known that other modifications may be made to the present invention, without departing the scope of the invention.

We claim:

1. An apparatus for use with lifting the rear of large vehicles, comprising:
at least two substantially parallel and horizontally extending frame extenders, adapted for communication with a receiving means rigidly connected to the undercarriage of a large vehicle;
at least one cross bar, substantially perpendicular to said frame extenders and rigidly connected to said frame extenders by a connecting means; and a
a mounting means for removably attaching said cross bar to a standard towing truck.

2. The apparatus according to claim 1, further comprising:
at least two slider arms extending substantially horizontally from the opposing ends of said cross bar and in rigid communication with said connecting means;
said slider arms each having a top surface and an opposing bottom surface
each said top surface in rigid connection with a pin surface; and
each said pin surface rigidly connected to a vertically extending pin for contact with a second receiving means in rigid connection to the undercarriage of a large vehicle;

3. The apparatus according to claim 1, wherein said connecting means is at least one pair of box collar sections.

4. The apparatus according to claim 1, wherein said crossbar, said frame extenders, and said connecting means comprise square or rectangular cross-sectional steel tubing.

5. The apparatus according to claim 1, wherein the length of said cross bar is about 80 inches long.

6. The apparatus according to claim 1, wherein the length of said frame extenders is about 83 inches long.

7. The apparatus according to claim 2, wherein the cross-sectional dimensions of said slider arms are about 3.5 inches by 3.5 inches by 3/16 inches.

8. The apparatus according to claim 4, wherein said square steel tubing comprises dimensions of cross-section of about 3 inches by 3 inches by 5/16 inches.

9. An apparatus for use with lifting the rear of large vehicles, comprising:
at least two substantially parallel and horizontally extending frame extenders, adapted for communication with a receiving means rigidly connected to the undercarriage of a large vehicle;
at least one cross bar, substantially perpendicular to said frame extenders and rigidly connected to said frame extenders by a connecting means;
a mounting means for removably attaching said cross bar to a standard towing truck;
at least two slider arms extending substantially horizontally from the opposing ends of said cross bar and in rigid communication with said connecting means;
said slider arms each having a top surface and an opposing bottom surface;
each said top surface in rigid connection with a pin surface; and
each said pin surface rigidly connected to a vertically extending pin for contact with a second receiving means in rigid connection to the undercarriage of a large vehicle;

10. The apparatus according to claim 1, wherein said connecting means is at least one pair of box collar sections.

11. The apparatus according to claim 9, wherein said crossbar, said frame extenders, and said connecting means comprise square or rectangular cross-sectional steel tubing.

12. The apparatus according to claim 9, wherein the length of said cross bar is about 80 inches long.

13. The apparatus according to claim 9, wherein the length of said frame extenders is about 83 inches long.

14. The apparatus according to claim 9, wherein the cross-sectional dimensions of said slider arms are about 3.5 inches by 3.5 inches by 3/16 inches.

15. The apparatus according to claim 10, wherein said square steel tubing comprises dimensions of cross-section of about 3 inches by 3 inches by 5/16 inches.

16. An arrangement for towing a large vehicle, comprising a rear lifting cradle removably mounted to the wrecker forks of a standard towing truck and in communication with a receiving means mounted to the undercarriage of said vehicle;
said rear lifting cradle having at least two substantially parallel and horizontally extending frame extenders, at least one cross bar substantially perpendicular to said frame extenders and rigidly connected to said frame extenders by a connecting means, a mounting means for removably mounting said cross bar to a standard towing truck; and
said undercarriage further comprising a main structural frame extending horizontally to a point short of the rear end of said large vehicle;
said receiving means comprising at least one pair of rear axle support plates extending vertically downward from said undercarriage, each said support plate having a receiving hole parallel to the main axis of said large vehicle and in line with said frame extenders of said rear lifting cradle for removably receiving said frame extenders horizontally; and
at least one pair of downwardly extending jack posts, positioned at points between the rear wheel and rear end of said large vehicle and in line with said frame extenders, for preventing the bowing of said frame extenders under lifting conditions.

17. Arrangement for towing a large vehicle according to claim 10, wherein:
said rear lifting cradle further comprises at least two slider arms extending substantially horizontally from the opposing ends of said cross bar and in rigid communication with said connecting means, a top surface and an opposing bottom surface, each said top surface in rigid connection with a substantially vertical pin; and
said undercarriage further comprises at least one pair of jack plates substantially positioned at said rear end of said under carriage, each said jack plate having a substantially vertical locator hole for receiving said pin of said rear lifting cradle.

18. An arrangement for towing a large vehicle, comprising a rear lifting cradle removably mounted to the wrecker forks of a standard towing truck and in communication with a receiving means mounted to the undercarriage of said vehicle;
said rear lifting cradle comprising:
(a) at least two substantially parallel and horizontally extending frame extenders;
(b) at least one cross bar substantially perpendicular to said frame extenders and rigidly connected to said frame extenders by a connecting means;
(c) a mounting means for removably mounting said cross bar to a standard towing truck;
(d) at least two slider arms, each said sliding arm having a top surface and an opposing bottom surface and extending substantially horizontally from the opposing ends of said cross bar and in rigid communication with said connecting means, said top surface in rigid connection with a substantially vertical pin;
said undercarriage further comprising a main structural frame extending horizontally to a point short of the rear end of said large vehicle, at least one pair of jack plates substantially positioned at said rear end of said undercarriage, each said jack plate having a substantially vertical locator hole for receiving said pin of said rear lifting cradle;
said receiving means comprising at least one pair of rear axle support plates extending vertically downward from said undercarriage, each said support plate having a receiving hole parallel to the main axis of said large vehicle and in line with said frame extenders of said rear lifting cradle for removably receiving said frame extenders horizontally;
at least one pair of downwardly extending jack posts, positioned at points between the rear wheel and rear end of said large vehicle and in line with said frame extenders, for preventing the bowing of said frame extenders under lifting conditions;
